(19) United States
(12) Patent Application Publication
(10) Pub. No.: US 2016/0127231 A1
(43) Pub. Date: May 5, 2016

(54) INFORMATION PROCESSING SYSTEM, METHOD, AND MANAGEMENT DEVICE

(71) Applicant: FUJITSU LIMTED, Kawsaki-shi (JP)

(72) Inventor: Masahiro SATO, Yokohama (JP)

(21) Appl. No.: 14/861,229

(22) Filed: Sep. 22, 2015

(30) Foreign Application Priority Data
Oct. 30, 2014 (JP) 2014-221818

(51) Int. Cl. H04L 12/741; H04L 12/931; H04L 29/12; H04L 12/713

(52) U.S. Cl. CPC H04L 45/74; H04L 45/586; H04L 49/70; H04L 61/256

(57) ABSTRACT

A device is configured to refer correspondence relationship information, obtain pieces of information on first packets that are transmitted and received to and from a virtual machine coupled to the device through a first interface from among interfaces and pieces of information on second packets that are transmitted and received to and from a virtual machine coupled to the through a second interface from among the interfaces when the correspondence relationship information is changed, and determine that a virtual router is deployed on the virtual machine when either the transmission source address or the destination address is identical between the set of the first packets and the set of the second packets, the virtual router transferring a packet between the first interface and the second interface and translating transmission source addresses or transmission destination addresses between a set of the first packets and a set of the second packets.

### CROSS-REFERENCE TO RELATED APPLICATION

This application is based upon and claims the benefit of priority of the prior Japanese Patent Application No. 2014-221818, filed on Oct. 30, 2014, the entire contents of which are incorporated herein by reference.

### FIELD

The embodiments discussed herein are related to an information processing system, a method, and a management device.

### BACKGROUND

When a failure occurs in a cloud operation of a data center, it is important for an operator to grasp a coupling configuration of a system including a virtual router, a virtual machine (VM), and the like, used by a user in order to identify the influence range and troubleshoots the failure. The VM is a machine virtually achieved by software on a physical machine, and the virtual router is router deployed on the VM.

Recently, due to the emergence of virtual appliances such as a VM and a virtual router, cases have been increasing in which a user installs a virtual router on a VM and uses the virtual router. Therefore, the operator identifies a VM on which a virtual router is deployed, as one of operations for grasping a coupling configuration of an information processing system.

FIGS. 21, 22, and 23 are diagrams illustrating a virtual router identification method in a related art. In FIG. 21, a Server 01 and a Server 02 respectively indicate physical machines, and a Switch 01, a Switch 02, and a Switch 03 respectively indicate physical switches. The Server 01 is coupled to the Switch 01, and the Server 02 is coupled to the Switch 03. The Switch 01 and the Switch 03 are coupled to the Switch 02, and the Switch 02 is coupled to a management device 9. The management device 9 manages the coupling configuration of the information processing system, and identifies a VM on which a virtual router has been deployed.

A virtual switch vSwitch 01 and a virtual machine VM 01 operate on the Server 01. The VM 01 is coupled to the vSwitch 01 through an interface (IF) P01 of the vSwitch 01. The IF may be referred to as a port. A virtual switch vSwitch 02 and virtual machines VMs 02 to 04 operate on the Server 02. The VM 02 is coupled to the vSwitch 02 through the IFs P01 and P02 of the vSwitch 02, and the VM 03 is coupled to the vSwitch 02 through an IF P03 of the vSwitch 02, and the VM 04 is coupled to the vSwitch 02 through an IF P04 of the vSwitch 02.

Information on the coupling configuration of the system is managed using a configuration information table 96. The configuration information table 96 is a table in which pieces of information on a host name, a MAC, an IP, a virtual switch name, and a coupling IF are associated with each other. The host name is a name of a VM. The MAC is a MAC address of the VM. The IP is an IP address of the VM. The virtual switch name is a name of a virtual switch to which the VM is coupled. The coupling IF is a name of an IF through which the VM is coupled to the virtual switch.

The management device 9 extracts a VM coupled to a plurality of IFs as a candidate on which a virtual router is to be deployed, based on the pieces of information in the configuration information table 96. In FIG. 21, the VM 02 is coupled to the two IFs, so that the management device 9 extracts the VM 02 as the candidate. In addition, as illustrated in FIG. 22, the management device 9 captures traffic in the IFs through which the extracted VM is coupled to the virtual switch, collects flow information, and registers the flow information to a flow information table 92.

An Index, an IF, a transmission source IP, and a destination IP are included in the flow information. The index is a number used to identify a flow. The IF is an IF in which the flow has been detected. The transmission source IP is an IP address of a VM that is a transmission source. The destination IP is an IP address of a VM that is a destination. In FIG. 22, traffic is captured in the P01 and the P02 of the vSwitch 02.

In addition, the management device 9 identifies the VM of the candidate as a VM on which a virtual router has been deployed when there are flows between different IFs having an identical transmission source IP and an identical destination IP, with reference to the flow information table 92.

In FIG. 22, as illustrated in the flow information table 92, a transmission source IP of a flow that has been detected in the P01 is “2.0.0.2”, and a destination IP of the flow that has been detected in the P01 is “1.0.0.2”. In addition, a transmission source IP of a flow that has been detected in the P02 is also “2.0.0.2”, and a destination IP of the flow that has been detected in the P02 is also “1.0.0.2”. Thus, the flow that has been detected in the P01 and the flow that has been detected in the P02 have the identical transmission source IP and identical destination IP, so that the management device 9 identifies the VM 02 as the VM on which the virtual router has been deployed.

As illustrated in FIG. 23, the VM 02 operates as a virtual router between the VM 01 and the VM 03. For example, a packet transmitted from the VM 03 to the VM 01 is transmitted from the P02 of the vSwitch 02 to the VM 02, and transmitted from the VM 02 to the VM 01 through the P01 of the vSwitch 02. In FIG. 23, the transmission source MAC indicates a MAC address of a VM that is a transmission source, and the destination MAC indicates a MAC address of a VM that is a destination. In addition, “Index 1” indicates a flow in which the index is “1”, and “Index 2” indicates a flow in which the index is “2”.

In capturing of packets, a related art is known in which identifiers that have been obtained from packets are stored so as to be associated with a transmission source address, and a transmission source indicated by the transmission source address that has been stored so as to be associated with the identifiers is detected as an address translation transmission device when the identifiers are not monotonically increased. In addition, a related art is known in which a change in a configuration in a cloud environment is detected in real time by recognizing a change in a correspondence relationship between a physical server and a virtual machine from an analysis result of packets that have been mirrored from packets that flow through a plurality of virtual machines.

As an example of the related art, International Publication Pamphlet No. WO2008/146399 and Japanese Laid-open Patent Publication No. 2012-4781 are known.

### SUMMARY

According to an aspect of the invention, an information processing system includes: a plurality of information processing devices; and a management device that includes a memory and a processor coupled to the memory, and that is configured to manage the plurality of information processing devices. The memory is configured to store correspondence relationship information indicating a correspondence relationship between a virtual switch that operates in one of the plurality of information processing devices, a plurality of interfaces included in the virtual switch, and a virtual machine coupled to one of the plurality of interfaces. The processor is configured to: obtain pieces of information on a plurality of first packets that are transmitted and received to and from a virtual machine coupled to the management device through a first interface from among the plurality of interfaces and pieces of information on a plurality of second packets that are transmitted and received to and from a virtual machine coupled to the management device through a second interface from among the plurality of interfaces when the correspondence relationship information is changed, and determine that a virtual router is deployed on the virtual machine when either the transmission source address or the destination address is identical between the set of the first packets and the set of the second packets, the virtual router transferring a packet between the first interface and the second interface and translating transmission source addresses or transmission destination addresses between a set of the first packets and a set of the second packets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating a virtual router identification method according to an embodiment;

FIG. 2 is a diagram illustrating a configuration of an information processing system according to the embodiment;

FIG. 3 is a diagram illustrating a function configuration of a management device;

FIG. 4 is a diagram illustrating an example of a VM management table;

FIG. 5 is a diagram illustrating an example of a flow information table;

FIG. 6 is a diagram illustrating setting of capture and collection of captured data;

FIG. 7 is a diagram illustrating a Netflow;

FIG. 8 is a diagram illustrating an example of a packet format of a Netflow packet;

FIG. 9 is a flowchart illustrating a flow of processing by a capture setting control unit;

FIG. 10 is a flowchart illustrating a flow of processing by a captured data processing unit and a virtual router identification unit;

FIG. 11 is a diagram illustrating a configuration example of an information system;

FIG. 12 is a diagram illustrating the initial state (in which a VM is not created);

FIG. 13 is a diagram illustrating a state in which a VM 01 has been created;

FIG. 14 is a diagram illustrating a state in which a VM 02 has been created;

FIG. 15 is a diagram illustrating a state in which a VM 03 has been created;

FIG. 16 is a diagram illustrating a state in which a VM 04 has been created;

FIG. 17 is a diagram illustrating a state in which communication from the VM 04 to the VM 01 has been started;

FIG. 18 is a diagram illustrating a state in which communication from the VM 03 to the VM 01 has been started;

FIG. 19 is a diagram illustrating identification of a virtual router;

FIG. 20 is a diagram illustrating a hardware configuration of a computer that executes a management program according to the embodiment;

FIGS. 21, 22, and 23 are diagrams illustrating a virtual router identification method in a related art;

FIG. 24 is a diagram illustrating network address translation (NAT);

FIGS. 25 and 26 are diagram illustrating a problem of the virtual router identification method in the related art.

### DESCRIPTION OF EMBODIMENTS

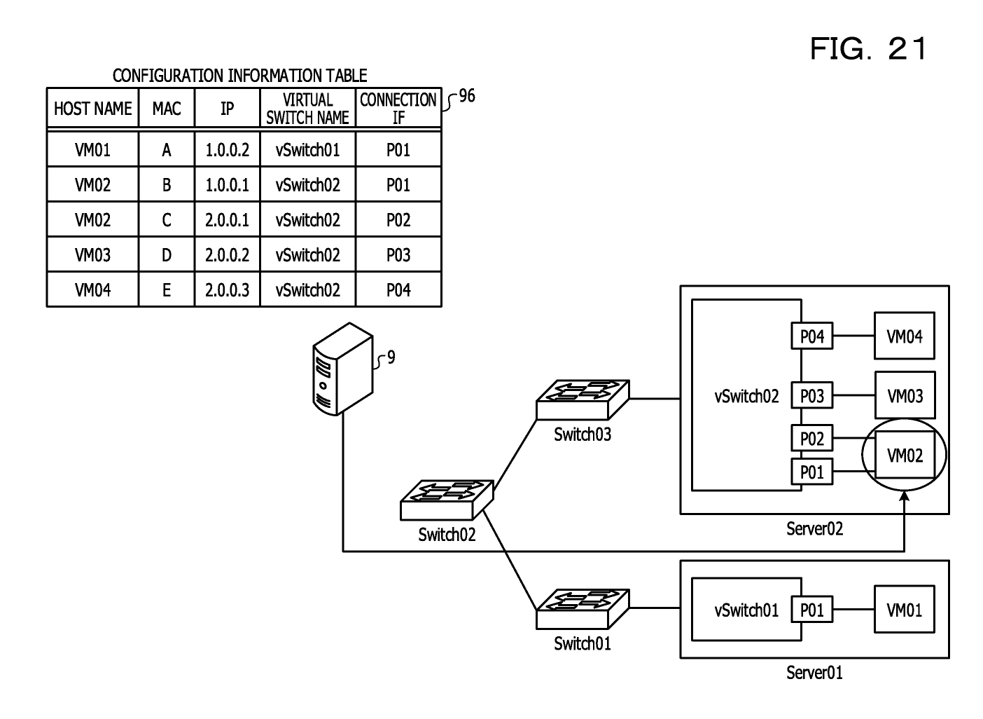

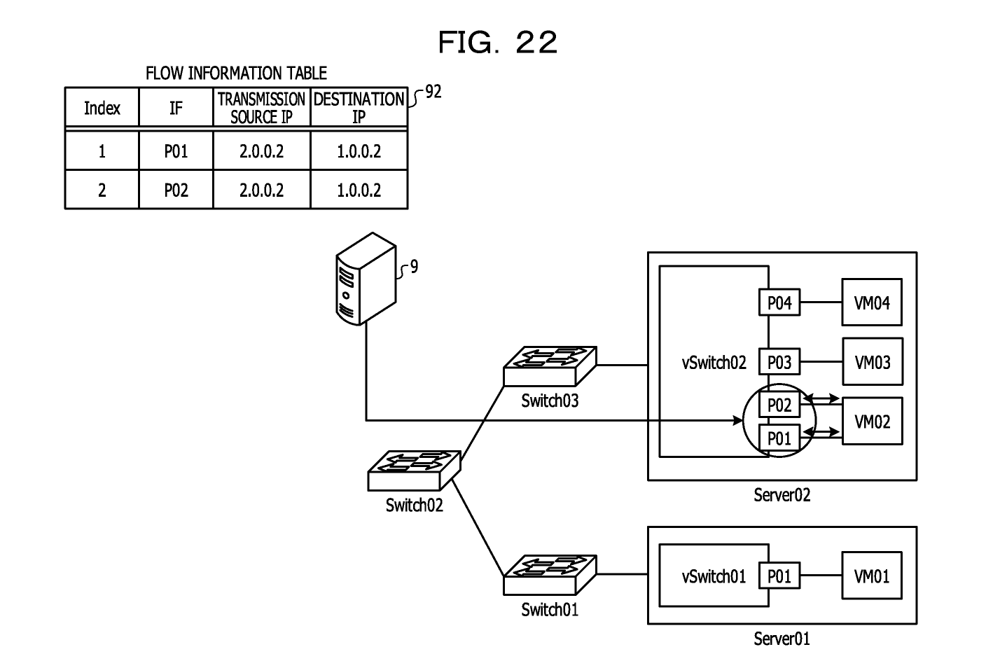

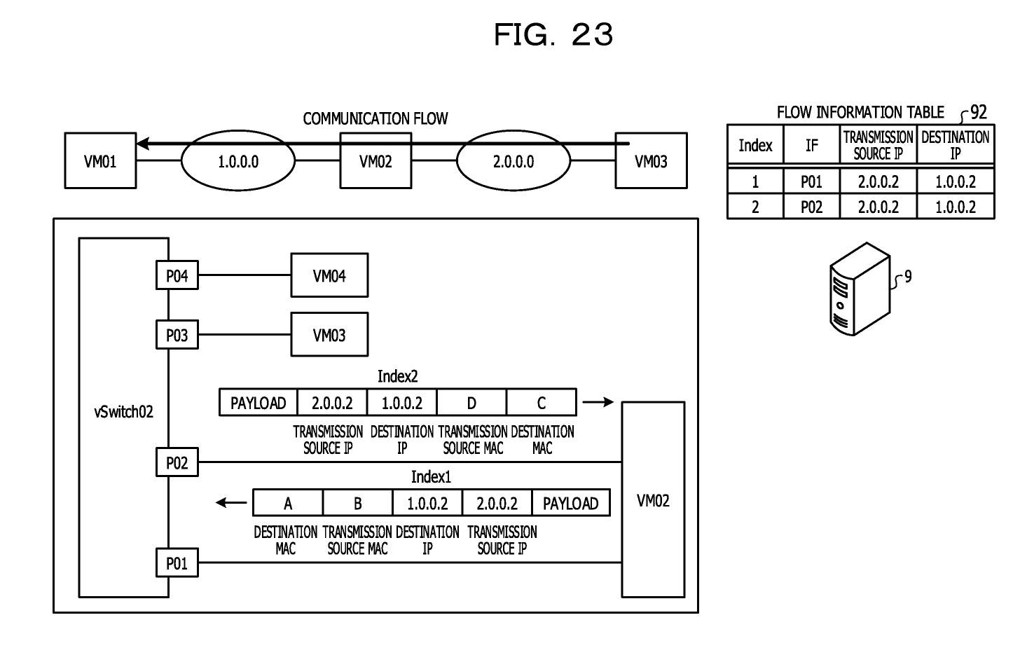

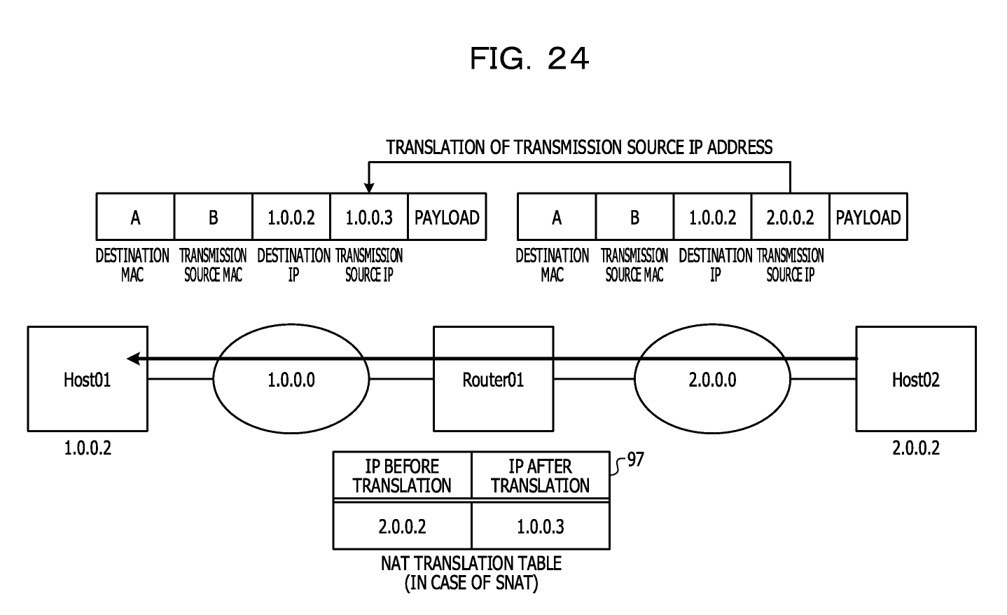

In the virtual router identification method in the related art illustrated in FIGS. 21, 22, and 23, there is a problem that it is difficult to identify a virtual router of a NAT setting. Here, the NAT is a technology by which an address of a packet is translated in accordance with a translation table. FIG. 24 is a diagram illustrating the NAT. The NAT includes transmission source NAT (SNAT) in which a transmission source address is translated and destination NAT (DNAT) in which a destination address is translated, and generally, there are many cases in which the SNAT is used. Specifically, FIG. 24 is a diagram illustrating the SNAT.

In FIG. 24, a NAT translation table 97 is a table in which an IP before translation and an IP after translation are associated with each other, and is used for the NAT translation. As illustrated in FIG. 24, in the SNAT, a transmission source IP of a packet that has been transmitted from a Host 02, the IP address of which is “2.0.0.2”, is translated into “1.0.0.3” by a Router 01 based on the NAT translation table 97.

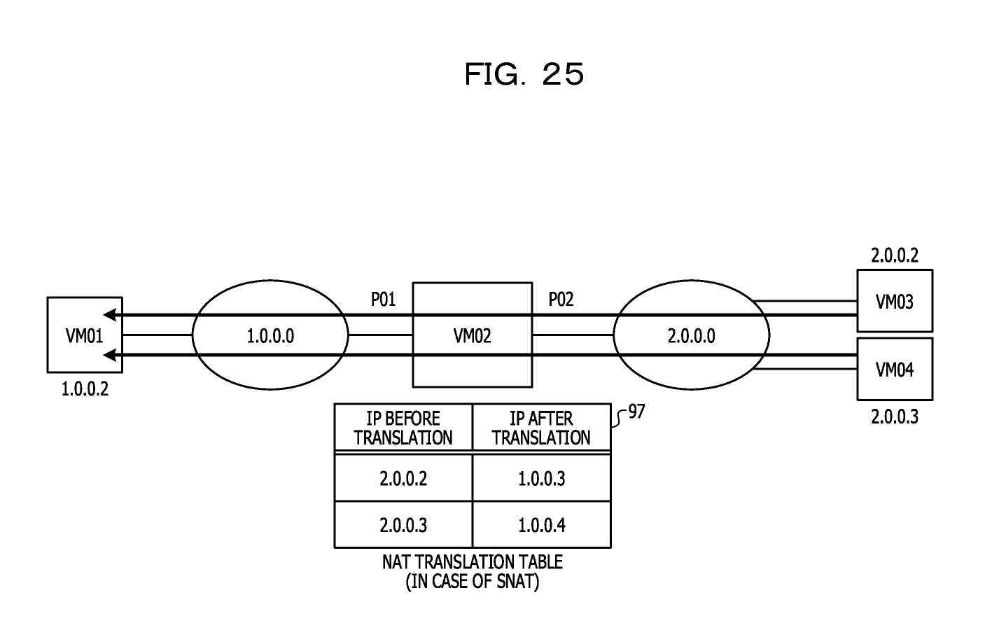

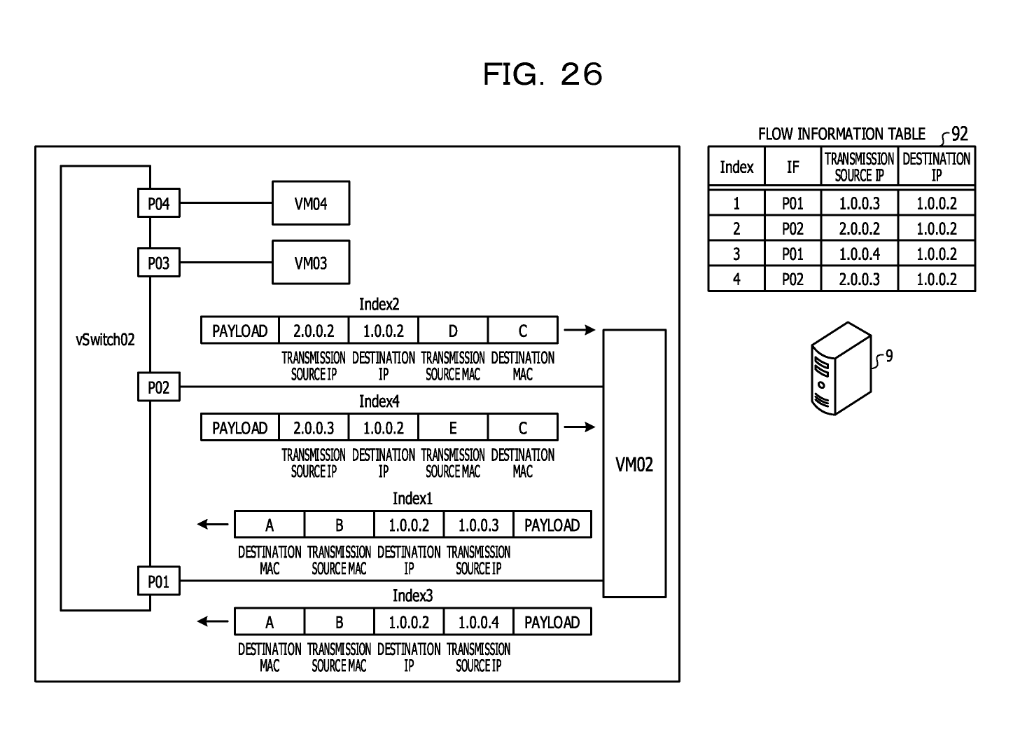

FIGS. 25 and 26 are diagrams illustrating a problem of the virtual router identification method in the related art. In FIG. 25, a virtual router of a SNAT setting is deployed on the VM 02, and the VM 03 transmits a packet to the VM 01 through the virtual router, and the VM 04 transmits a packet to the VM 01 through the virtual router. In this case, “2.0.0.2” that is the transmission source IP of the packet transmitted from the VM 03 is translated into “1.0.0.3” by the SNAT, and “2.0.0.3” that is the transmission source IP of a packet transmitted from the VM 04 is translated into “1.0.0.4” by the SNAT.

Therefore, as illustrated in the flow information table 92 in FIG. 26, in the packet that has been transmitted from the VM 03, the transmission source IP that has been detected in the P02 is “2.0.0.2”, and the transmission source IP that has been detected in the P01 is “1.0.0.3”, so that the transmission source IPs are different from each other. Similarly, in the packet that has been transmitted from the VM 04, the transmission source IP that has been detected in the P02 is “2.0.0.3”, and the transmission source IP that has been detected in the P01 is “1.0.0.4”, so that the transmission source IPs are different from each other. Thus, the management device 9 does not detect flows between different IFs having an identical transmission source IP or destination IP, and it is difficult for the management device 9 to identify establishment of a virtual router on the VM 02.

In FIG. 26, in the transmission of the packet from the VM 03 to the VM 01, the flow having an Index 1 indicates the flow that has been detected in the P01, and the flow having an Index 2 indicates the flow that has been detected in the P02. In addition, in the transmission of the packet from the VM 04 to the VM 01, the flow having an Index 3 indicates the flow that has been detected in the P01, and the flow having an Index 4 indicates the flow that has been detected in the P02.

An object of an embodiment is to identify a virtual machine on which a virtual router that performs address translation has been deployed even when the virtual router exists in an information processing system.

Embodiments are described below with reference to drawings. The technology discussed herein is not limited to the embodiments.

### Embodiments

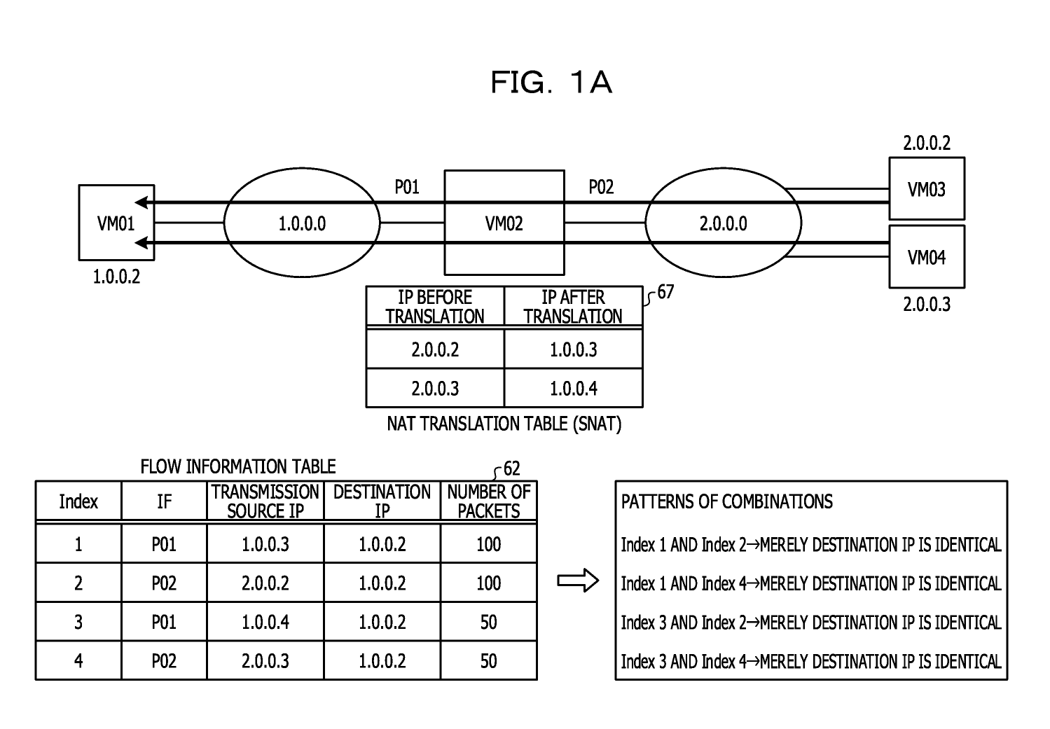

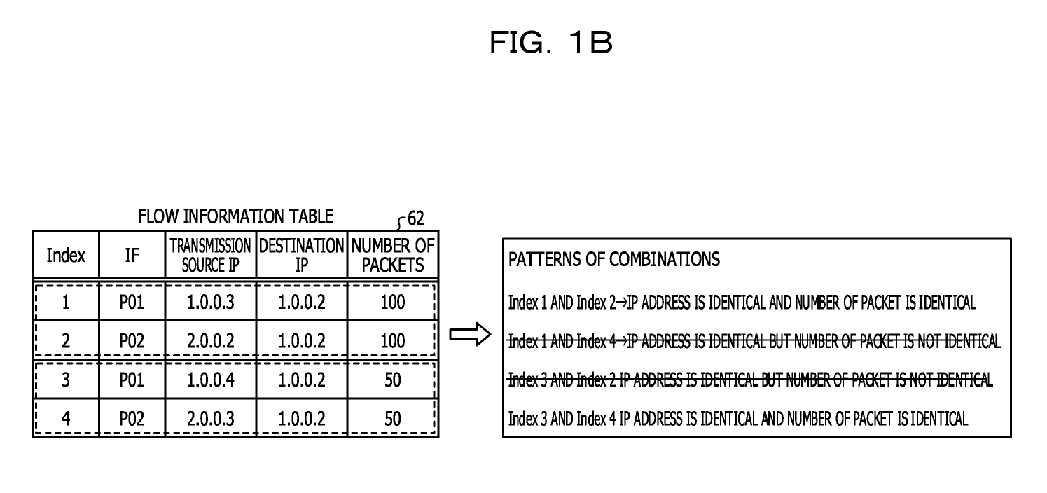

A virtual router identification method according to an embodiment is described below. FIGS. 1A and 1B are diagrams illustrating the virtual router identification method according to the embodiment. In FIG. 1A, a virtual router of a SNAT setting is deployed on a VM 02, and a VM 03 transmits a packet to a VM 01 through the virtual router, and a VM 04 transmits a packet to the VM 01 through the virtual router. In this case, “2.0.0.2” that is the transmission source IP of the packet that has been transmitted from the VM 03 is translated into “1.0.0.3” by the SNAT, and “2.0.0.3” that is the transmission source IP of the packet that has been transmitted from the VM 04 is translated into “1.0.0.4” by the SNAT.

Therefore, as illustrated in a flow information table 62, in the packet that has been transmitted from the VM 03, the transmission source IP that has been detected in an IF P02 is “2.0.0.2”, and the transmission source IP that has been detected in an IF P01 is “1.0.0.3”, so that the transmission source IPs are different from each other. Similarly, in the packet that has been transmitted from the VM 04, the transmission source IP that has been detected in the P02 is “2.0.0.3”, and the transmission source IP that has been detected in the P01 is “1.0.0.4”, so that the transmission source IPs are different from each other.

A virtual router of a NAT setting translates either an IP address of a transmission source or a transmission destination. Therefore, a management device according to the embodiment determines that a virtual router is deployed on a VM to which different IFs are coupled when flows between the different IFs having either an identical transmission source IP address or transmission destination IP address exist in flow information.

In FIG. 1A, a combination of flows between the different IFs P01 and P02 having either an identical destination IP address includes a combination of an Index 1 and an Index 2, a combination of the Index 1 and an Index 4, a combination of an Index 3 and the Index 2, and a combination of the Index 3 and the Index 4. Thus, the management device according to the embodiment identifies the VM 02 to which the IFs P01 and P02 are coupled as a VM to which a virtual router has been deployed.

In addition, when a combination of flows between the different IFs having an identical transmission source IP address or destination IP address and an identical number of packets exists, the management device according to the embodiment identifies a set of the flows as an identical flow before and after NAT translation. In addition, the management device according to the embodiment identifies addresses of the other IP, which are not identical, as addresses to be translated. The number of packets is the number of packets that are counted within a certain time.

For example, the number of packets is identical in the combination of the Index 1 and the Index 2 and the combination of the Index 3 and the Index 4, from among the four combinations illustrated in FIG. 1A, but the number of packets is different in the combination of the Index 1 and the Index 4 and the combination of the Index 3 and the Index 2. Thus, as illustrated in FIG. 1B, the management device according to the embodiment identifies the Index 1 and the Index 2 as an identical flow, and identifies “1.0.0.3” and “2.0.0.2” as transmission source IP addresses before and after translation. In addition, the management device according to the embodiment identifies the Index 3 and the Index 4 as an identical flow, and identifies “1.0.0.4” and “2.0.0.3” as transmission source IP addresses before and after translation.

As described above, when flows exist that have either an identical transmission source IP address or destination IP address between different IFs coupled to an identical VM, the management device according to the embodiment determines that a virtual router is deployed on the VM to which the IFs have been coupled. Thus, even when the virtual router that performs address translation exists in the information processing system, the management device according to the embodiment may identify the VM on which the virtual router has been deployed.

In addition, when a combination of flows exists that have an identical transmission source IP address or destination IP address and an identical number of packets between different IFs coupled to the identical VM, the management device according to the embodiment identifies the set of the flows as an identical flow before and after NAT translation. In addition, the management device according to the embodiment identifies addresses of the other IP, which are not identical, as addresses to be translated. Thus, the management device according to the embodiment may identify IP addresses before and after translation by the virtual router that performs address translation.

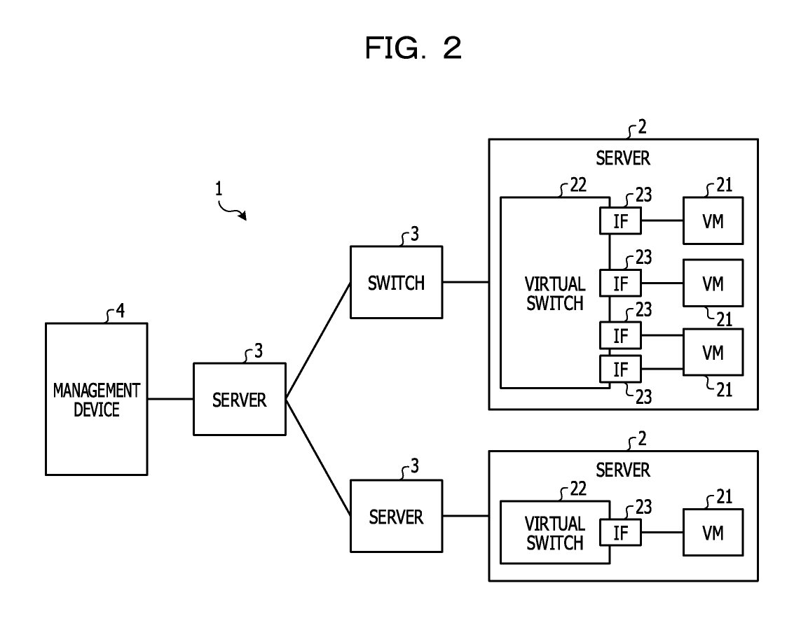

A configuration of an information processing system according to the embodiment is described below. FIG. 2 is a diagram illustrating a configuration of an information processing system according to the embodiment. As illustrated in FIG. 2, an information processing system 1 includes two servers 2, three switches 3, and a management device 4. Each of the servers 2 is coupled to the corresponding switch 3, and the switch 3 corresponding to each of the servers 2 is coupled to the management device 4 through a further switch 3. Here, for convenience of explanation, the two servers 2 and the three switches 3 are merely illustrated, but the information processing system 1 may include three or more servers 2 and four or more switches 3.

The server 2 is a computer that executes information processing. VMs 21 and a virtual switch 22 operate on each of the servers 2. Each of the VMs 21 is a virtual computer that operates on the server 2 that is a physical computer. Virtual appliances such as a virtual server and a virtual router are deployed on the VM 21.

The virtual switch 22 is a virtual switch that operates on the server 2 that is the physical computer. The virtual switch 22 includes one or more IFs (IFs) 23, and is coupled to the VM 21 through the IF 23. Each of the VMs 21 is coupled to the one or more IFs 23, and communicates with a further VM 21 and the like through the virtual switch 22.

In FIG. 2, for convenience of explanation, the case is described in which merely a single virtual switch 22 operates on the server 2, but a plurality of virtual switches 22 may operate on the server 2. In addition, any number of VMs 21 may operate on the server 2, and the virtual switch 22 may include any number of IFs 23.

The switch 3 is a device that performs physical coupling of devices such as the server 2 and the management device 4. The switches 3 forms a computer network by coupling the plurality of servers 2 to each other.

The management device 4 collects pieces of information on the VMs 21 that have been created on the server 2, and collects flow information from packets that pass through the IFs 23. In addition, the management device 4 identifies a VM on which a virtual router of a NAT setting has been deployed, based on the pieces of information on the VMs 21 and the flow information that has been collected from the packets that pass through the IFs 23, and identifies a set of IP addresses that are to be translated by NAT translation.

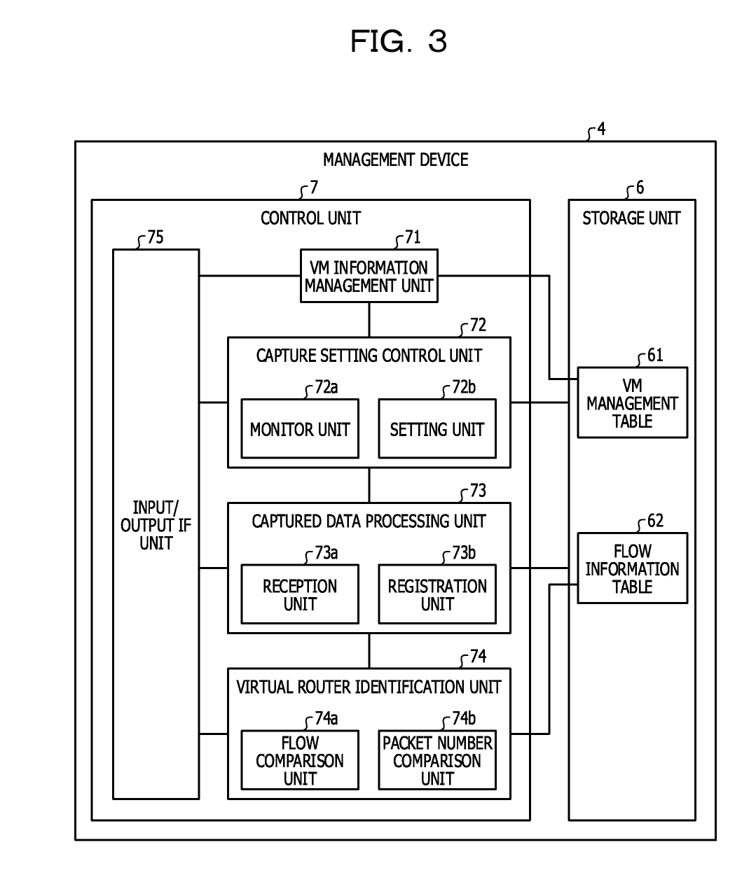

FIG. 3 is a diagram illustrating a function configuration of the management device 4. As illustrated in FIG. 3, the management device 4 includes a storage unit 6 and a control unit 7. The storage unit 6 is a function unit that stores information used by the control unit 7, and stores a VM management table 61 and the flow information table 62. The control unit 7 is a function unit that performs control of the management device 4, and includes a VM information management unit 71, a capture setting control unit 72, a captured data processing unit 73, a virtual router identification unit 74, and an input/output IF unit 75.

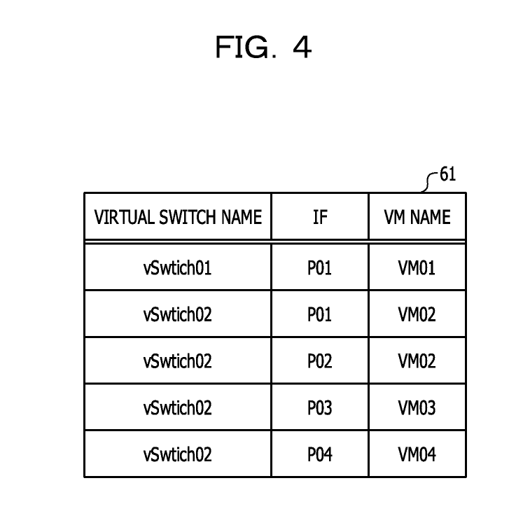

The VM management table 61 is a table used to manage pieces of information on the VMs 21 that operate on the server 2. FIG. 4 is a diagram illustrating an example of the VM management table 61. As illustrated in FIG. 4, the VM management table 61 associates a virtual switch name, an IF, with a VM name.

The virtual switch name is a name used to identify a virtual switch 22. The IF is a name used to identify an IF 23 included in the virtual switch 22. The VM name is a name used to identify a VM 21 coupled to the IF 23. For example, a VM 21, the name of which is VM 01, is coupled to a P01 that is an IF 23 included in a virtual switch 22, the name of which is vSwitch 01.

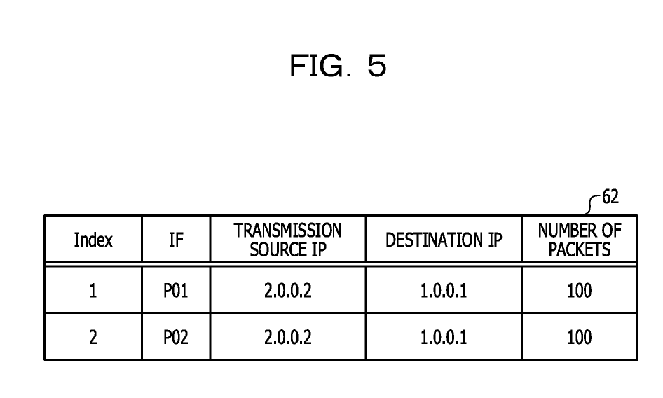

The flow information table 62 is a table to which information on a flow of communication between the VMs 21 is registered. FIG. 5 is a diagram illustrating an example of the flow information table 62. As illustrated in FIG. 5, the flow information table 62 associates an Index, an IF, a transmission source IP, and a destination IP, with the number of packets.

The Index is a number used to identify a flow. The IF is the name of an IF 23 in which the flow has been detected. The transmission source IP is an IP address of a VM 21 that is a transmission source of a packet transferred through the flow. The destination IP is an IP address of a VM 21 that is a destination of the packet transferred through the flow. The number of packets is the number of packets that are transferred through the flow within a certain time.

For example, a flow in which the number to be identified is “1” is detected in the IF 23, the name of which is P01, and an IP address of a VM 21 that is a transmission source of the packet transferred through the flow is “2.0.0.2”. In addition, an IP address of a VM 21 that is a transmission destination of the packet transferred through the flow is “1.0.0.1”, and the number of packets transferred through the flow within the certain time is 100.

The VM information management unit 71 updates information on the VM management table 61 based on information from the server 2. For example, the VM information management unit 71 updates the information on the VM management table 61 when a VM 21 is added or deleted to or from the VM management table 61.

The capture setting control unit 72 performs setting and control related to detection of a flow in the IF 23. That is, the capture setting control unit 72 performs setting and control related to capture of information on a packet that passes through the IF 23. The capture setting control unit 72 includes a monitoring unit 72a and a setting unit 72b.

The monitoring unit 72a monitors the VM management table 61, and notifies the setting unit 72b of update of the VM management table 61. The setting unit 72b performs setting and control related to the capture, based on the update content when the update of the VM management table 61 is notified from the monitoring unit 72a.

When a VM 21 in which the number of IFs 23 coupled to the virtual switch 22 is two or more is added to the VM management table 61, the setting unit 72b performs setting so that capture of information on packets that pass through the IFs 23 is valid for the IFs 23. In addition, when a VM 21 in which the number of IFs 23 coupled to the virtual switch 22 is two or more is deleted from the VM management table 61, the setting unit 72b performs setting so that capture of information on packets that pass through the IFs 23 is invalid for the IFs 23. The reason why a VM 21 in which the number of IFs 23 coupled to the virtual switch 22 is two or more is set as a target of capture is because a VM 21 on which a virtual router is deployed is coupled to two or more IFs 23 for reception and transmission of packets.

The captured data processing unit 73 registers the flow information to the flow information table 62, based on the captured data. The captured data processing unit 73 includes a reception unit 73a and a registration unit 73b. The reception unit 73a receives the captured data. The registration unit 73b registers the flow information to the flow information table 62, based on the data that has been received by the reception unit 73a.

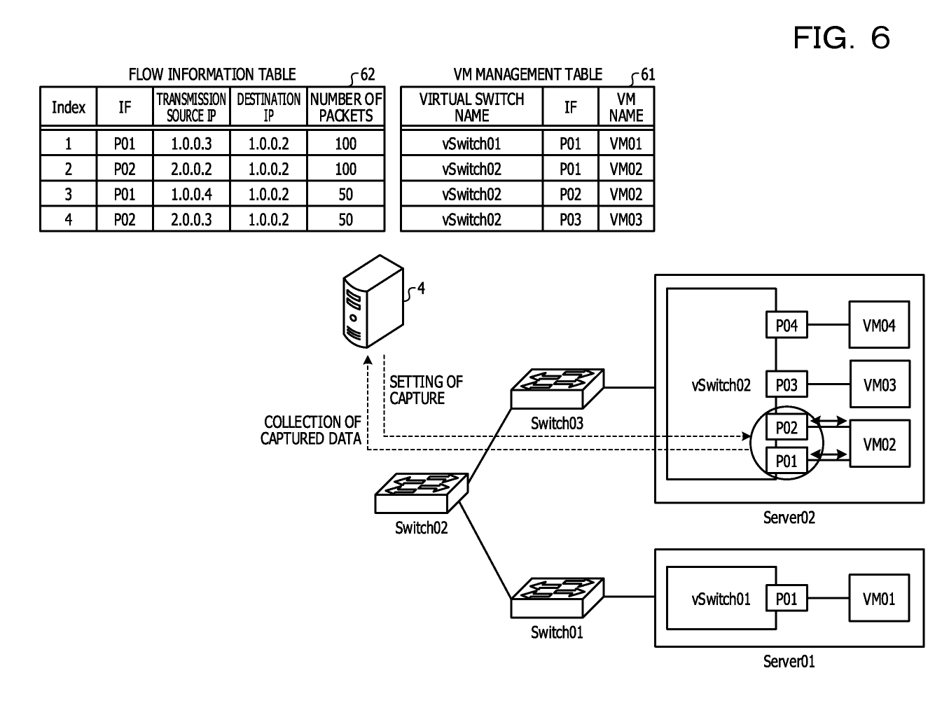

FIG. 6 is a diagram illustrating setting of capture and collection of captured data. In FIG. 6, Servers 01 and 02 correspond to the servers 2, and Switches 01 to 03 correspond to the switches 3. The Server 01 is coupled to the Switch 01, and the Server 02 is coupled to the Switch 03. The Switch 01 and the Switch 03 are coupled to the Switch 02, and the Switch 02 is coupled to the management device 4.

A vSwitch 01 corresponds to a virtual switch 22 that operates in the Server 01, and a vSwitch 02 corresponds to a virtual switch 22 that operates in the Server 02. A VM 01 corresponds to a VM 21 that operates in the Server 01, and a VM 02, a VM 03, and a VM 04 correspond to VMs 21 that operate in the Server 02. The VM 01 is coupled to the vSwitch 01 through an IF P01 of the vSwitch 01. The IF is referred to as a port. The VM 02 is coupled to the vSwitch 02 through the IFs P01 and P02 of the vSwitch 02, and the VM 03 is coupled to the vSwitch 02 through the IF P03 of the vSwitch 02, and the VM 04 is coupled to the vSwitch 02 through the IF P04 of the vSwitch 02.

As illustrated in FIG. 6, the VM 02 is coupled to vSwitch 02 through the two IFs P01 and P02. Thus, it is probable that a virtual router is deployed on the VM 02, so that setting is performed so that capture is valid for the IFs P01 and P02 of the vSwitch 02. Such setting is performed when the VM 02 is registered to the VM management table 61.

In addition, pieces of captured data for the IFs P01 and P02 of the vSwitch 02 is collected, and the flow information is registered to the flow information table 62 based on the collected data. In FIG. 6, registration of pieces of information on the flows of the Index 1 and the Index 3 for the IF P01 is performed, and registration of pieces of information on the flows of the Index 2 and the Index 4 for the IF P02 is performed.

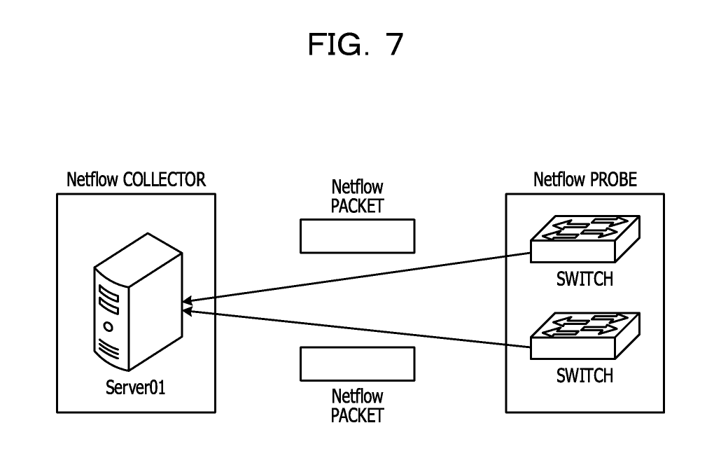

The data capture is performed, for example, using a Netflow. The Netflow is a network protocol used to collect pieces of IP traffic information that pass through network equipment. FIG. 7 is a diagram illustrating the Netflow. As illustrated in FIG. 7, in the Netflow, a Netflow probe collects data in a switch, and transmits the data to a Netflow collector using a Netflow packet. The Netflow collector manages the data that has been transmitted from the Netflow probe. In the embodiment, the Netflow probe collects data in the virtual switch 22, and the management device 4 operates as the Netflow collector.

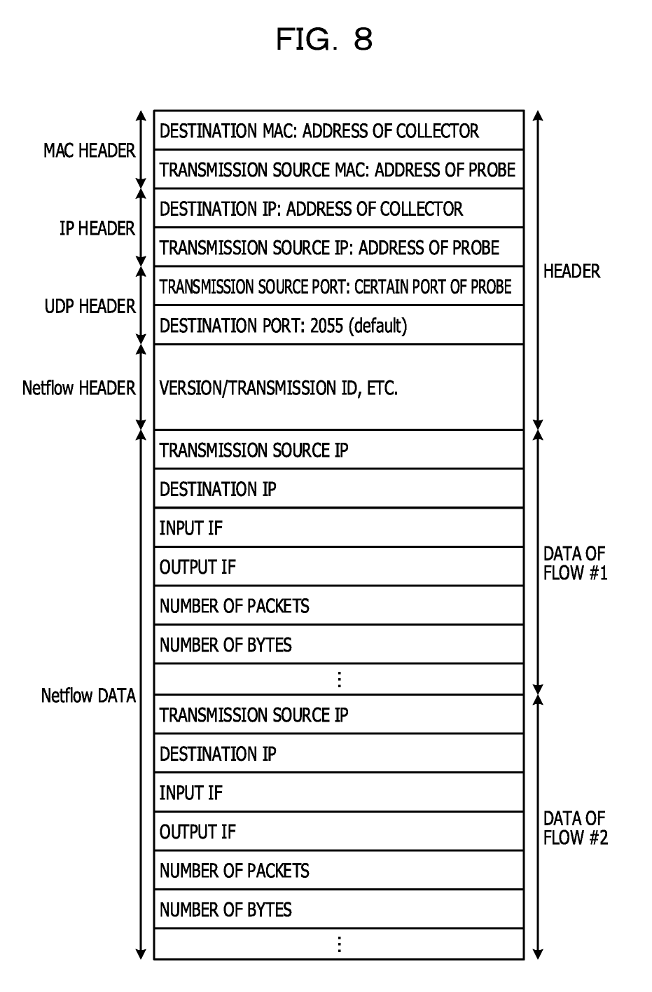

The data transmitted using the Netflow packet includes a transmission source IP, a destination IP, an IF name, and the number of packets. FIG. 8 is a diagram illustrating an example of a packet format of a Netflow packet. As illustrated in FIG. 8, the Netflow packet includes a header and Netflow data. The header includes a MAC header, an IP header, a UDP header, and a Netflow header. The Netflow data includes pieces of data related to flows.

In FIG. 8, pieces of data of two flows that are flows #1 and #2 are included in the Netflow data. The data of the flow includes a transmission source IP, a destination IP, an input IF, an output IF, and the number of packets.

Returning to FIG. 3, the virtual router identification unit 74 identifies a VM 21 on which a virtual router of a NAT setting has been deployed, and identifies IP addresses before and after NAT translation. The input/output IF unit 75 is an IF used to perform communication with the server 2.

The virtual router identification unit 74 includes a flow comparison unit 74a and a packet number comparison unit 74b. The flow comparison unit 74a compares transmission source IPs and destination IPs between two flows of different IFs 23, from among flows that have been registered to the flow information table 62, and identifies a VM 21 on which a virtual router of a NAT setting has been deployed. The packet number comparison unit 74b identifies IP addresses before and after NAT translation by comparing the number of packets between the two flows used for the identification of the VM 21 on which the virtual router has been deployed.

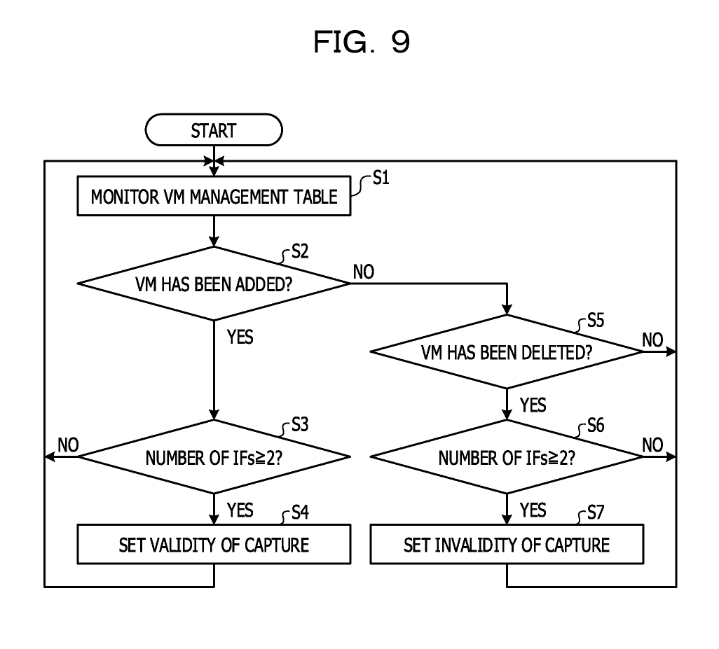

A flow of processing by the capture setting control unit 72 is described below. FIG. 9 is a flowchart illustrating the processing by the capture setting control unit 72. As illustrated in FIG. 9, the capture setting control unit 72 monitors the VM management table 61 (Step S1).

After that, the capture setting control unit 72 determines whether a VM 21 has been added to the VM management table 61 when the VM management table 61 is updated (Step S2). When the capture setting control unit 72 determines that the VM 21 has been added to the VM management table 61, the capture setting control unit 72 determines whether the number of IFs 23 to which the added VM 21 is coupled is two or more (Step S3).

When the capture setting control unit 72 determines that the number of IFs 23 to which the added VM 21 is coupled is two or more, the capture setting control unit 72 performs setting so that capture is valid for the IFs 23 to which the added VM 21 is coupled (Step S4), and the flow returns to Step S1. When the capture setting control unit 72 determines that the number of IFs 23 to which the added VM 21 is coupled is not two or more, in the capture setting control unit 72, the flow returns to Step S1.

In addition, in Step S2, when the capture setting control unit 72 determines that the VM 21 has not been added to the VM management table 61, the capture setting control unit 72 determines whether the VM 21 has been deleted from the VM management table 61 (Step S5). When the capture setting control unit 72 determines that the VM 21 has not been deleted from the VM management table 61, in the capture setting control unit 72, the flow returns to Step S1. When the capture setting control unit 72 determines that the VM 21 has been deleted from the VM management table 61, the capture setting control unit 72 determines whether the number of IFs 23 to which the deleted VM 21 is coupled is two or more (Step S6).

When the capture setting control unit 72 determines that the number of IFs 23 to which the deleted VM 21 is coupled is two or more, the capture setting control unit 72 performs setting so that capture is invalid for the IFs 23 to which the deleted VM 21 is coupled (Step S7), and the flow returns to Step S1. When the capture setting control unit 72 determines that the number of IFs 23 to which the deleted VM 21 is coupled is not two or more, in the capture setting control unit 72, the flow returns to Step S1.

The management device 4 may collect merely data that is useful for identification of a VM 21 on which a virtual router of a NAT setting has been deployed when the capture setting control unit 72 performs setting so that capture is valid or invalid as described above.

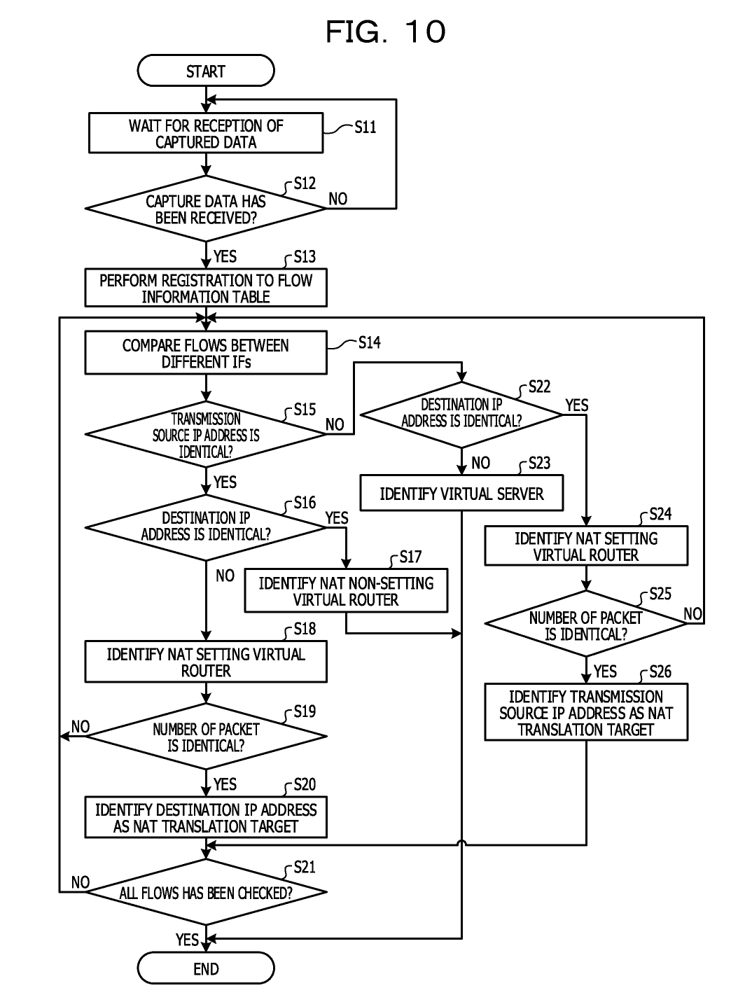

A flow of processing by the captured data processing unit 73 and the virtual router identification unit 74 is described below. FIG. 10 is a flowchart illustrating the processing by the captured data processing unit 73 and the virtual router identification unit 74. As illustrated in FIG. 10, the captured data processing unit 73 waits for reception of captured data (Step S11).

In addition, the captured data processing unit 73 determines whether captured data has been received (Step S12), and when the captured data processing unit 73 determines that captured data has not been received, the flow returns to Step S11. When the captured data processing unit 73 determines that captured data has been received, the captured data processing unit 73 registers flow information to the flow information table 62, based on the captured data (Step S13).

In addition, the virtual router identification unit 74 compares flows of different IFs 23 (Step S14), and determines whether the flows have an identical transmission source IP address (Step S15). When the virtual router identification unit 74 determines that the flows have an identical transmission source IP address, the virtual router identification unit 74 determines whether the flows have an identical destination IP address (Step S16), and when the virtual router identification unit 74 determines that the flows have an identical destination IP address, the virtual router identification unit 74 identifies a NAT non-setting virtual router (Step S17), and the processing ends. The identification of the NAT non-setting virtual router is identification of a VM 21 on which a virtual router has been deployed to which NAT translation is not set.

When the virtual router identification unit 74 determines that the flows do not have an identical destination IP address, the virtual router identification unit 74 identifies a NAT setting virtual router (Step S18). The identification of the NAT setting virtual router is identification of a VM 21 on which a virtual router has been deployed to which NAT is set.

After that, the virtual router identification unit 74 determines whether the flows have an identical number of packets (Step S19), and when the virtual router identification unit 74 determines that the flows do not have an identical number of packets, the flow returns to Step S14. When the virtual router identification unit 74 determines that the flows have an identical number of packets, the virtual router identification unit 74 identifies the destination IP addresses as a NAT translation target (Step S20). After that, the virtual router identification unit 74 determines whether all flows have been checked (Step S21), when the virtual router identification unit 74 determines that not all of the flows have been checked, the processing returns to Step S14, and when the virtual router identification unit 74 determines that all of the flows have been checked, the processing ends.

In addition, in Step S15, when the virtual router identification unit 74 determines that the flows do not have an identical transmission source IP address, the virtual router identification unit 74 determines whether the flows have an identical destination IP address (Step S22). When the virtual router identification unit 74 determines that the flows do not have an identical destination IP address, the virtual router identification unit 74 identifies the VM 21 as a virtual server (Step S23), and the processing ends.

When the virtual router identification unit 74 determines that the flows have an identical destination IP address, the virtual router identification unit 74 identifies a NAT setting virtual router (Step S24). After that, the virtual router identification unit 74 determines whether the flows have an identical number of packets (Step S25), and when the virtual router identification unit 74 determines the flows do not have an identical number of packets, the flow returns to Step S14. When the virtual router identification unit 74 determines that the flows have an identical number of packets, the virtual router identification unit 74 identifies the transmission source IP address as a NAT translation target (Step S26), and the flow proceeds to Step S21.

As described above, the virtual router identification unit 74 identifies a virtual router that performs NAT translation by comparing flows of different IFs 23 with reference to the flow information table 62. Thus, the management device 4 may identify a VM 21 on which a virtual router that performs address translation has been deployed even when the virtual router exists in the information processing system.

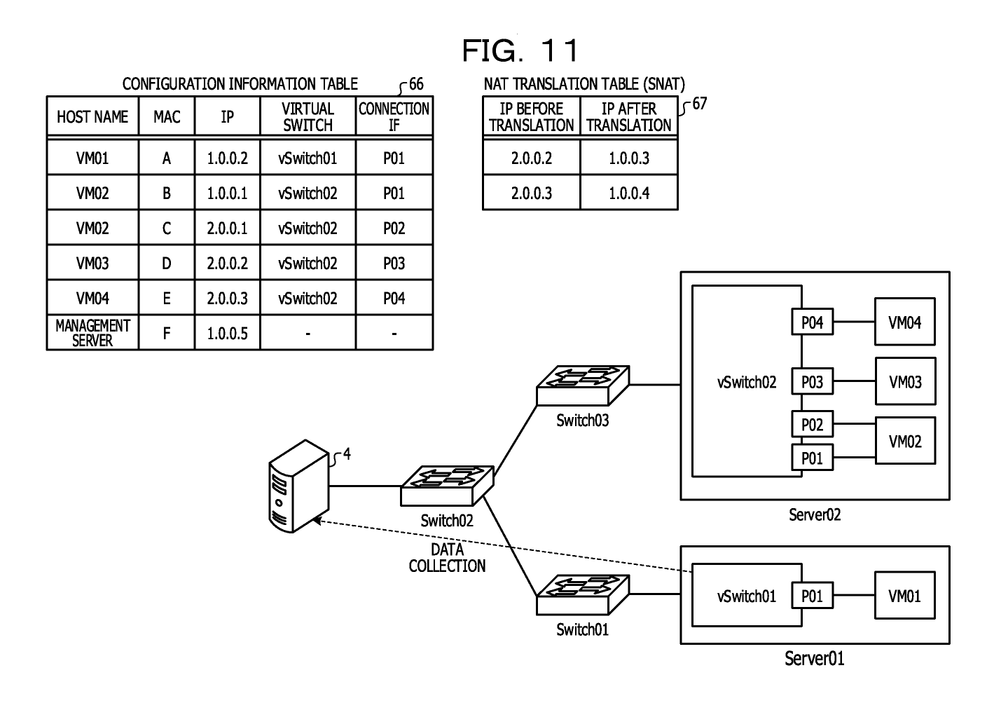

An example in which a virtual router of a NAT setting is identified is described below with reference to FIGS. 11 to 18. FIG. 11 is a diagram illustrating a configuration example of an information system. The example of the information system has a configuration similar to that of the information system illustrated in FIG. 6.

The configuration of the information system is managed by a configuration information table 66. As illustrated in FIG. 11, a host name, a MAC, an IP, a virtual switch, and a coupling IF are registered to the configuration information table 66. The host name is the name of a VM 21 or a management device 4 that operates as a host. The MAC is an MAC address of the host. The IP is an IP address of the host. The virtual switch has the name of a virtual switch 22 to which the VM 21 is coupled. The coupling IF is an IF 23 through which the VM 21 is coupled to the virtual switch 22.

For example, a VM 21, the name of which is VM 01, has a MAC address A, and is coupled to a virtual switch 22 the IP address of which is “1.0.0.2”, and the name of which is vSwitch 01, through an IF 23, the name of which is P01.

The virtual router to be identified performs SNAT translation using a NAT translation table 67, translates the transmission source IP address “2.0.0.2” into “1.0.0.3”, and translates the transmission source IP address “2.0.0.3” into “1.0.0.4”. In addition, the data collection interval of the Netflow, that is, an interval at which data is transmitted from the probe is one minute.

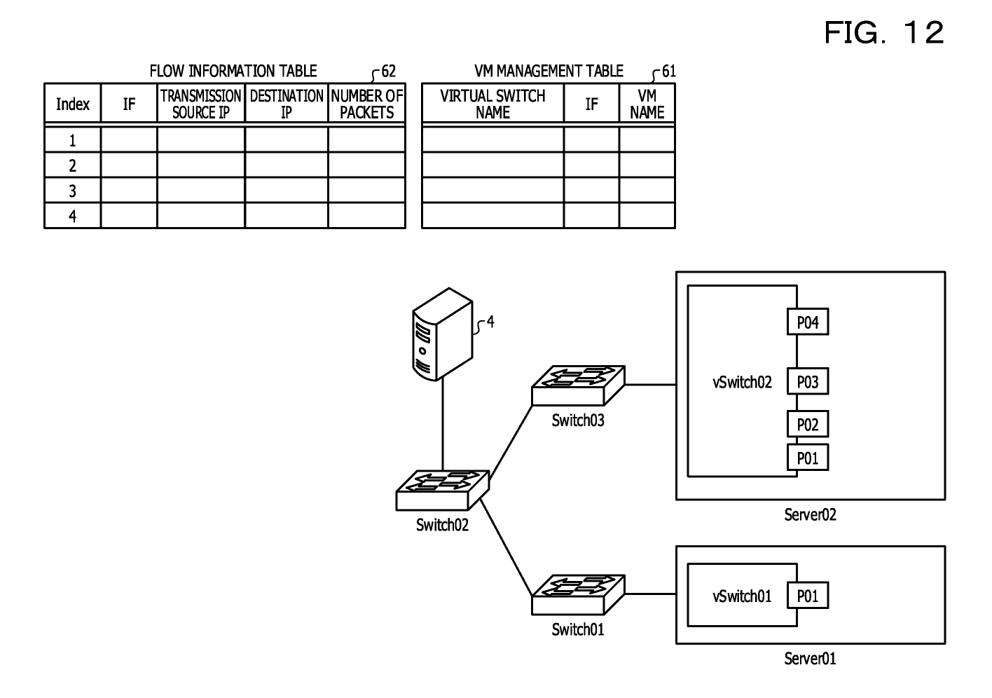

FIG. 12 is a diagram illustrating the initial state in which a VM is not created. As illustrated in FIG. 12, in the initial state, a VM 21 is not created. Therefore, information is not registered to the VM management table 61 and the flow information table 62.

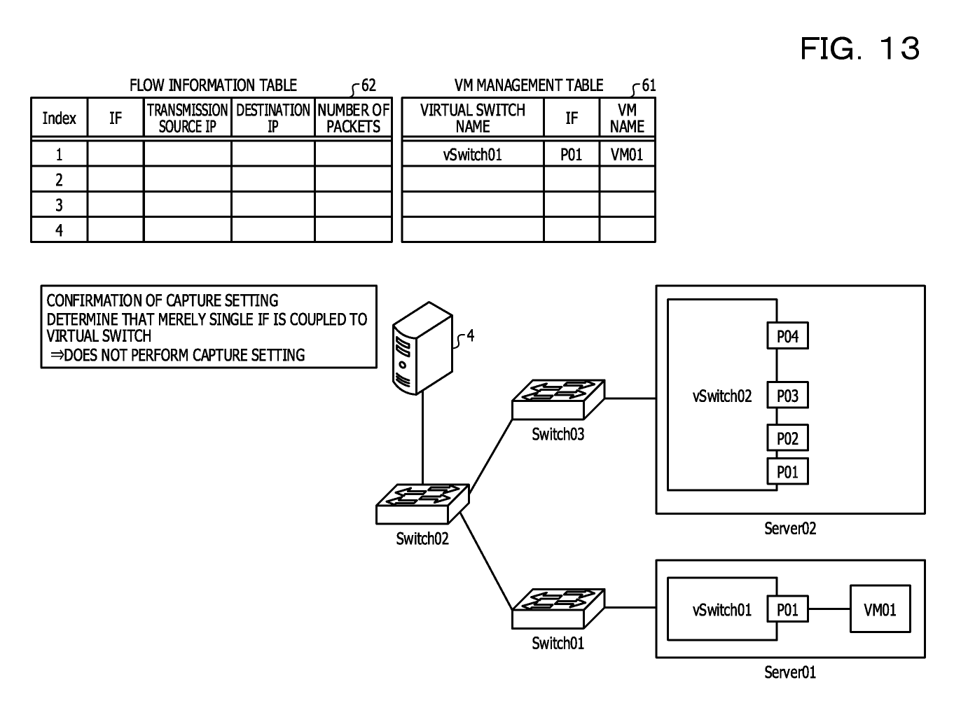

FIG. 13 is a diagram illustrating a state in which the VM 01 has been created. As illustrated in FIG. 13, when the VM 01 has been created, the names of the virtual switch 22 and the IF 23 to which the VM 01 is coupled are registered to the VM management table 61 so as to be associated with the VM 01. That is, the VM 01 as the VM name, the vSwitch 01 as the virtual switch name, and the P01 as the IF name are registered to the VM management table 61.

In addition, the capture setting control unit 72 confirms capture setting. The VM 01 is coupled to the vSwitch 01 merely through the single IF 23, so that the capture setting control unit 72 does not perform capture setting.

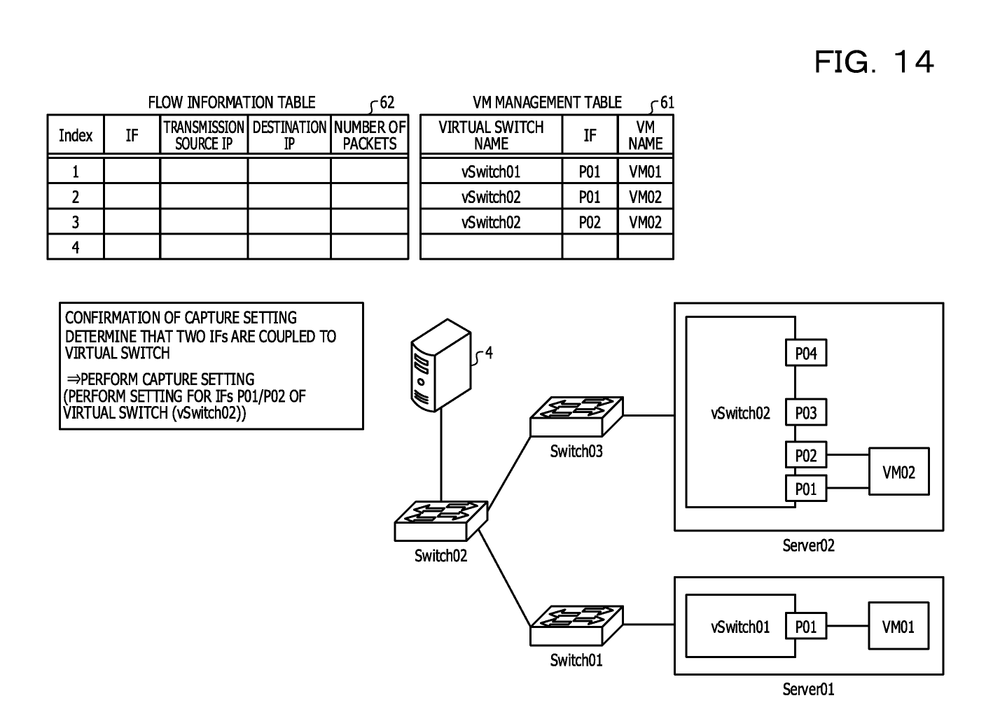

FIG. 14 is a diagram illustrating a state in which a VM 02 has been created. As illustrated in FIG. 14, the VM 02 is coupled to a vSwitch 02 through two IFs 23, so that the names of the virtual switch 22 and the IFs 23 to which the VM 02 is coupled are respectively registered to two rows of the VM management table 61 so as to be associated with the VM 02 when the VM 02 has been created. That is, the VM 02 as the VM name, the vSwitch 02 as the virtual switch name, and the P01 as the IF name are registered to the VM management table 61, and the VM 02 as the VM name, the vSwitch 02 as the virtual switch name, and the P02 as the IF name are also registered to the VM management table 61.

In addition, the capture setting control unit 72 confirms capture setting. The VM 02 is coupled to the vSwitch 02 through the two IFs 23, so that the capture setting control unit 72 performs capture setting. For example, the capture setting control unit 72 performs capture setting on the P01 and the P02 of the vSwitch 02.

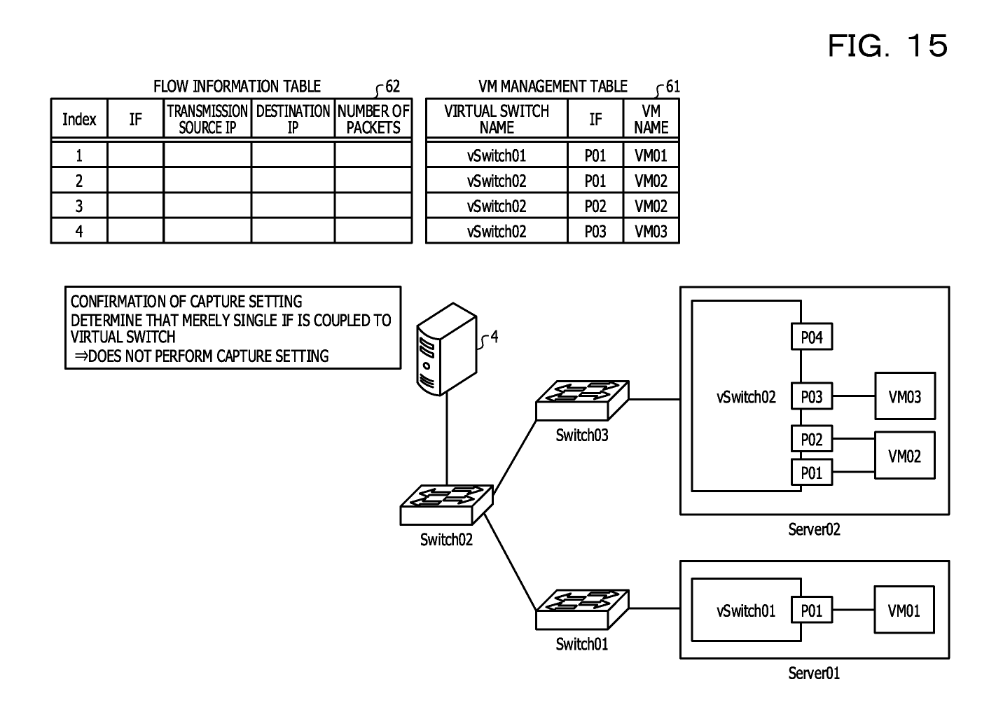

FIG. 15 is a diagram illustrating a state in which a VM 03 has been created. As illustrated in FIG. 15, when the VM 03 has been created, the names of a virtual switch 22 and an IF 23 to which the VM 03 is coupled are registered to the VM management table 61 so as to be associated with the VM 03. That is, the VM 03 as the VM name, the vSwitch 02 as the virtual switch name, and the P03 as the IF name are registered to the VM management table 61.

In addition, the capture setting control unit 72 confirms capture setting. The VM 03 is coupled to the vSwitch 02 merely through the single IF 23, so that the capture setting control unit 72 does not perform capture setting.

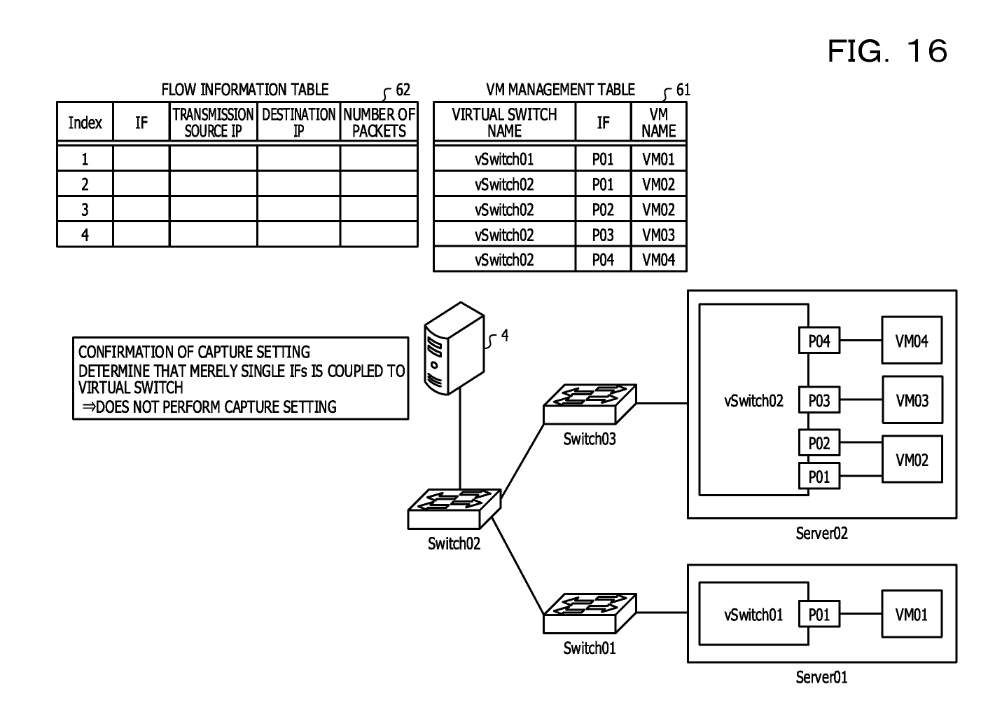

FIG. 16 is a diagram illustrating a state in which a VM 04 has been created. As illustrated in FIG. 16, when the VM 04 has been created, the names of a virtual switch 22 and an IF 23 to which the VM 04 is coupled are registered to the VM management table 61 so as to be associated with the VM 04. That is, the set of the VM 04 as the VM name, the vSwitch 02 as the virtual switch name, and the P04 as the IF name are registered to the VM management table 61.

In addition, the capture setting control unit 72 confirms capture setting. The VM 04 is coupled to the vSwitch 02 merely through the single IF 23, so that the capture setting control unit 72 does not perform capture setting.

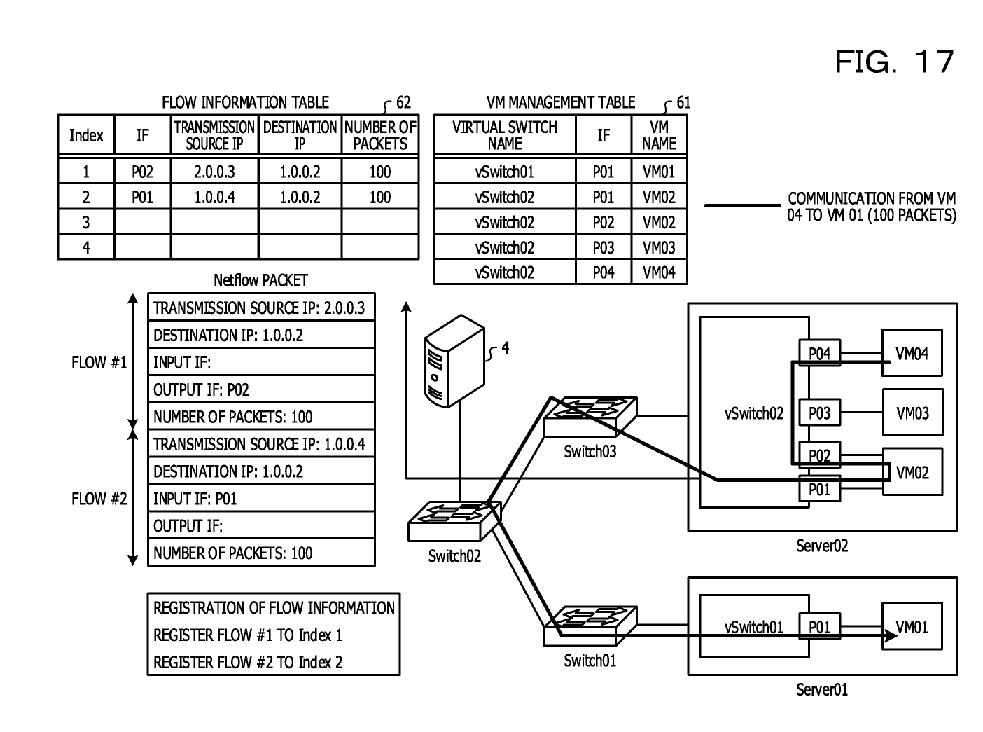

FIG. 17 is a diagram illustrating a state in which communication from the VM 04 to the VM 01 has been started. As illustrated in FIG. 17, pieces of captured data of the flows #1 and #2 are transmitted from the vSwitch 02 to the management device 4 using Netflow packets. The flow #1 corresponds to the data that has been captured in the P02 of the vSwitch 02, and the flow #2 corresponds to the data that has been captured in the P01 of the vSwitch 02.

The flow #1 is registered to the flow information table 62 as the Index 1, and the flow #2 is registered to the flow information table 62 as the Index 2. When the Index 1 and the Index 2 are compared with each other, the destination IP is identical as “1.0.0.2”, but the transmission sources IP are different from each other as “2.0.0.3” and “1.0.0.4”. In addition, the number of packets is identical as 100 between the flows.

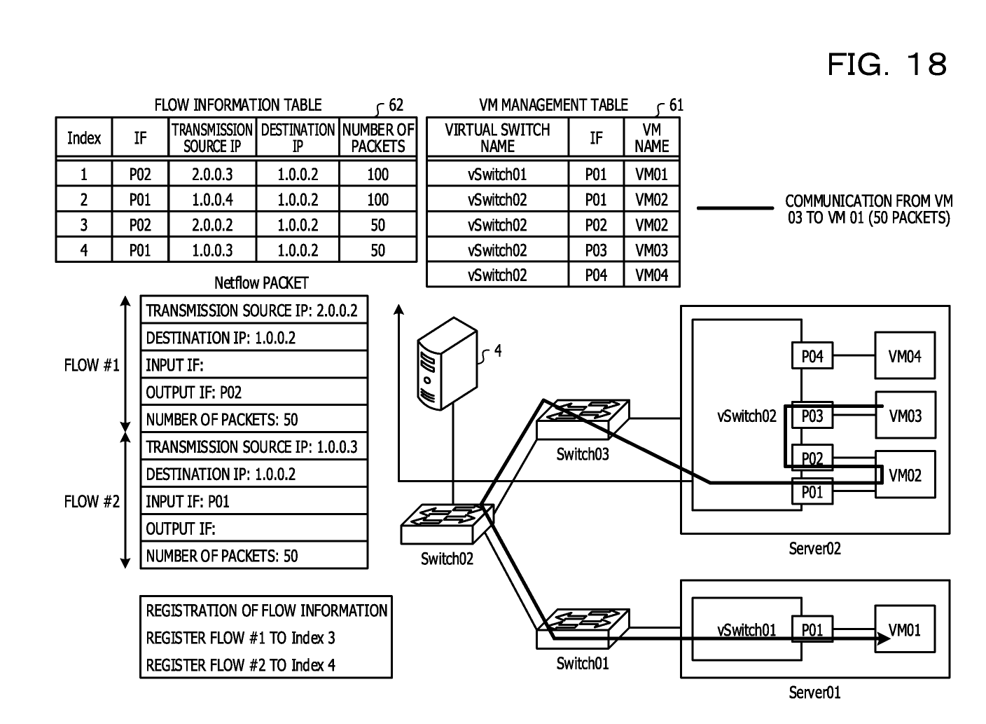

FIG. 18 is a diagram illustrating a state in which communication from the VM 03 to the VM 01 has been started. As illustrated in FIG. 18, pieces of captured data of the flows #1 and #2 are transmitted from the vSwitch 02 to the management device 4 using Netflow packets. The flow #1 corresponds to the data that has been captured in the P02 of the vSwitch 02, and the flow #2 corresponds to the data that has been captured in the P01 of the vSwitch 02.

The flow #1 is registered to the flow information table 62 as the Index 3, and the flow #2 is registered to the flow information table 62 as the Index 4. When the Index 3 and the Index 4 are compared with each other, the destination IP is identical as “1.0.0.2”, but the transmission sources IP are different from each other as “2.0.0.2” and “1.0.0.3”. In addition, the number of packets is identical as 50 between the flows.

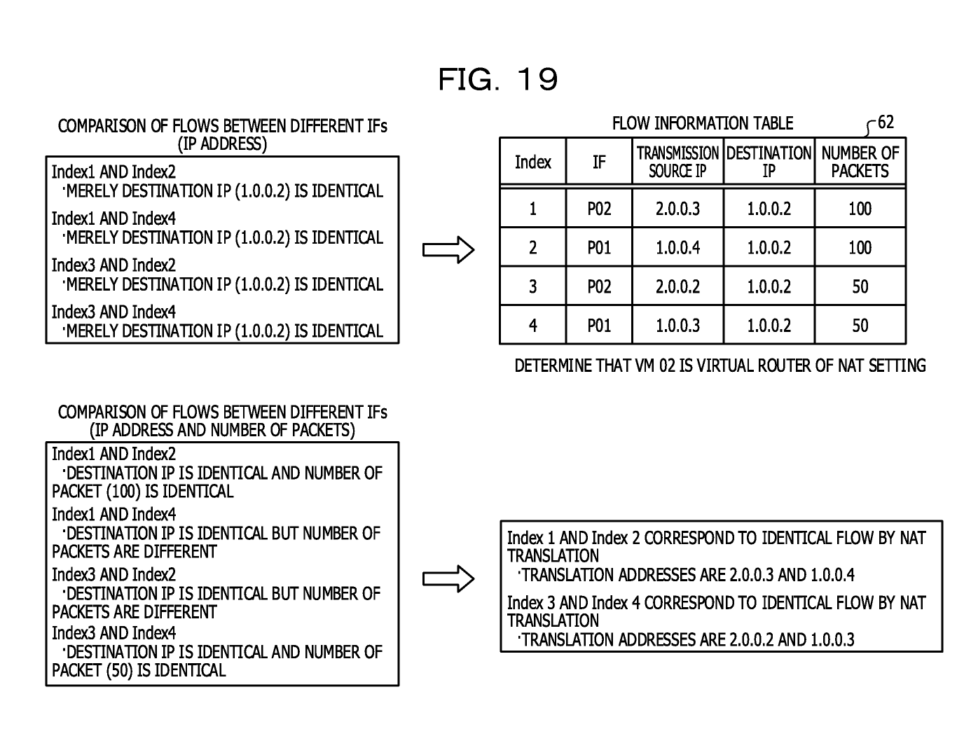

FIG. 19 is a diagram illustrating identification of a virtual router. As illustrated in FIG. 19, the virtual router identification unit 74 compares IP addresses between flows of different IFs 23 with reference to the flow information table 62. As a result, the virtual router identification unit 74 determines that merely the destination IP is identical between the Index 1 and the Index 2, that merely the destination IP is identical between the Index 1 and the Index 4, that merely the destination IP is identical between the Index 3 and the Index 2, and that merely the destination IP is identical between the Index 3 and the Index 4. Therefore, the virtual router identification unit 74 identifies the VM 02 coupled to the two IFs 23 as a virtual router of a NAT setting.

In addition, the virtual router identification unit 74 compares IP addresses and the number of packets between flows of different IFs 23 with reference to the flow information table 62. As a result, the virtual router identification unit 74 determines that the destination IP is identical and the number of packets, which is 100, is identical between the Index 1 and the Index 2, and that the destination IP is identical, but the number of packets is not identical between the Index 1 and the Index 4. In addition, the virtual router identification unit 74 determines that the destination IP is identical, but the number of packets is not identical between the Index 3 and the Index 2, and that the destination IP is identical, and the number of packets, which is 50, is identical between the Index 3 and the Index 4.

As a result, the virtual router identification unit 74 determines that the Index 1 and the Index 2 correspond to an identical flow by NAT translation, and that the transmission source IP addresses before and after translation are “2.0.0.3” and “1.0.0.4”. In addition, the virtual router identification unit 74 determines that the Index 3 and the Index 4 correspond to an identical flow by NAT translation, and that the transmission source IP addresses before and after translation are “2.0.0.2” and “1.0.0.3”.

As described above, in the embodiment, when a VM 21 coupled to the virtual switch 22 through a plurality of IFs 23 is created, the capture setting control unit 72 sets capture of piece of data of the plurality of IFs 23. In addition, the captured data processing unit 73 receives the pieces of captured data, and registers the flow information to the flow information table 62.

In addition, the virtual router identification unit 74 compares IP addresses between flows of different IFs 23 in the flow information table 62, identifies a set of the flows having either an identical destination IP or transmission source IP, and identifies a virtual router of a NAT setting. Thus, the management device 4 may identify a VM 21 on which the virtual router that performs address translation has been deployed even when the virtual router exists in the information processing system.

In addition, the virtual router identification unit 74 compares IP addresses and the number of packets between flows of different IFs 23 in the flow information table 62, and identifies the set of flows that have either an identical destination IP or transmission source IP and the identical number of packets. Thus, the management device 4 may identify an identical flow by NAT translation and the IP addresses before and after translation, in addition to the VM 21 on which the virtual router has been deployed.

In the embodiment, the management device is described above, but a management program including a function similar to that of the management device may be obtained by achieving the configuration included in the management device using software. Here, a computer that executes the management program is described below.

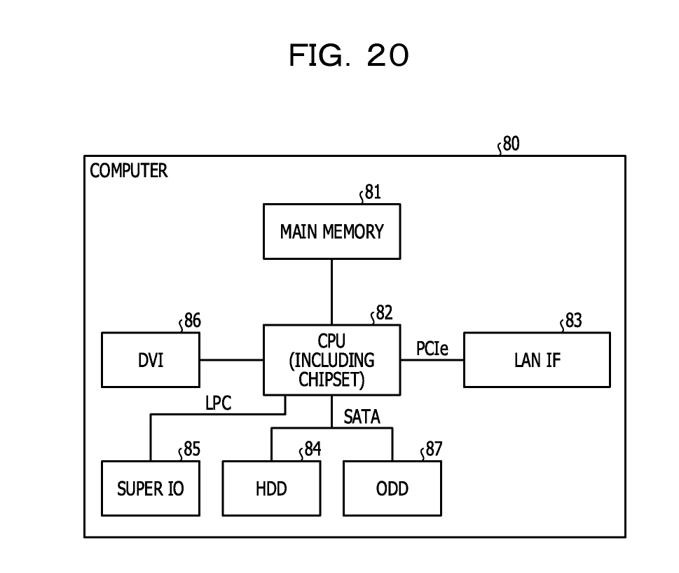

FIG. 20 is a diagram illustrating a hardware configuration of the computer that executes the management program according to the embodiment. As illustrated in FIG. 20, a computer 80 includes a main memory 81, a central processing unit (CPU) 82, a local area network (LAN) IF 83, and a hard disk drive (HDD) 84. In addition, the computer 80 further includes a super input output (IO) 85, a digital visual IF (DVI) 86, and an optical disk drive (ODD) 87.

The main memory 81 is a memory that stores a program, a result in the middle of execution of the program, and the like. The CPU 82 is a central processing unit that reads the program from the main memory 81 and executes the program. The CPU 82 is a chipset that includes a memory controller.

The LAN IF 83 is an IF used to couple the computer 80 to a further computer through a LAN. The HDD 84 is a disk device that stores a program and data, and the super IO 85 is an IF used to couple the computer 80 to an input device such as a mouse and a keyboard. The DVI 86 is an IF used to couple the computer 80 to a liquid crystal display device, and the ODD 87 is a device that performs reading and writing of a DVD.

The LAN IF 83 is coupled to the CPU 82 through PCI express (PCIe), and the HDD 84 and the ODD 87 are coupled to the CPU 82 through serial advanced technology attachment (SATA). The super IO 85 is coupled to the CPU 82 through low pin count (LPC).

In addition, the management program executed in the computer 80 is stored in a DVD, read from the DVD by the ODD 87, and installed to the computer 80. Alternatively, the management program is stored in a database or the like of a further computer system coupled to the computer 80 through the LAN IF 83, read from the database, and installed to the computer 80. In addition, the installed management program is stored in the HDD 84, and read to the main memory 81, and executed by the CPU 82.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of information processing devices; and
a management device that includes a memory and a processor coupled to the memory, and that is configured to manage the plurality of information processing devices, wherein
the memory is configured to store correspondence relationship information indicating a correspondence relationship between a virtual switch that operates in one of the plurality of information processing devices, a plurality of interfaces included in the virtual switch, and a virtual machine coupled to one of the plurality of interfaces, and
the processor is configured to:
obtain pieces of information on a plurality of first packets that are transmitted and received to and from a virtual machine coupled to the management device through a first interface from among the plurality of interfaces and pieces of information on a plurality of second packets that are transmitted and received to and from a virtual machine coupled to the management device through a second interface from among the plurality of interfaces when the correspondence relationship information is changed, and
determine that a virtual router is deployed on the virtual machine when either the transmission source address or the destination address is identical between the set of the plurality of first packets and the set of the plurality of second packets, the virtual router transferring a packet between the first interface and the second interface and translating transmission source addresses or transmission destination addresses between the set of the plurality of first packets and the set of the plurality of second packets.

2. The information processing system according to claim 1, wherein the processor is configured to:
determine whether the number of first packets and the number of second packets are identical to each other when it is determines that the virtual router is deployed on the virtual machine, and
identify addresses before and after translation by the virtual router when it is determined that the number of first packets and the number of second packets are identical to each other.

3. The information processing system according to claim 1, wherein the processor is configured to:
determine whether an added virtual machine is coupled to two or more interfaces when the correspondence relationship information is changed due to addition of the virtual machine to the correspondence relationship information, and
perform setting that pieces of information on the plurality of first packets and pieces of information on the plurality of second packets are obtained when the added virtual machine is coupled to the two or more interfaces.

4. The information processing system according to claim 1, wherein the processor is configured to:
determine whether a deleted virtual machine is coupled to two or more interfaces when the correspondence relationship information is changed due to deletion of the virtual machine from the correspondence relationship information, and
perform setting so that pieces of information on the plurality of first packets and pieces of information on the plurality of second packets are not obtained when the deleted virtual machine is coupled to the two or more interfaces.

5. A method of managing by a management device, the management device managing a plurality of information processing devices in information processing system, the method comprising:
referring correspondence relationship information indicating a correspondence relationship between a virtual switch that operates in one of the plurality of information processing devices, a plurality of interfaces included in the virtual switch, and a virtual machine coupled to one of the plurality of interfaces;
obtaining pieces of information on a plurality of first packets that are transmitted and received to and from a virtual machine coupled to the management device through a first interface from among the plurality of interfaces and pieces of information on a plurality of second packets that are transmitted and received to and from a virtual machine coupled to the management device through a second interface from among the plurality of interfaces when the correspondence relationship information is changed; and
determining that a virtual router is deployed on the virtual machine when either the transmission source address or the destination address is identical between the set of the plurality of first packets and the set of the plurality of second packets, the virtual router transferring a packet between the first interface and the second interface and translating transmission source addresses or transmission destination addresses between the set of the plurality of first packets and the set of the plurality of second packets.

6. The method according to claim 5, further comprising:
determining whether the number of first packets and the number of second packets are identical to each other when it is determines that the virtual router is deployed on the virtual machine; and
identifying addresses before and after translation by the virtual router when it is determined that the number of first packets and the number of second packets are identical to each other.

7. The method according to claim 5, further comprising:
determining whether an added virtual machine is coupled to two or more interfaces when the correspondence relationship information is changed due to addition of the virtual machine to the correspondence relationship information; and
performing setting that pieces of information on the plurality of first packets and pieces of information on the plurality of second packets are obtained when the added virtual machine is coupled to the two or more interfaces.

8. The method according to claim 5, further comprising:
determining whether a deleted virtual machine is coupled to two or more interfaces when the correspondence relationship information is changed due to deletion of the virtual machine from the correspondence relationship information; and
performing setting so that pieces of information on the plurality of first packets and pieces of information on the plurality of second packets are not obtained when the deleted virtual machine is coupled to the two or more interfaces.

9. A management device configured to manage a plurality of information processing devices in an information processing system, the management device comprising:
a memory configured to store correspondence relationship information indicating a correspondence relationship between a virtual switch that operates in one of the plurality of information processing devices, a plurality of interfaces included in the virtual switch, and a virtual machine coupled to one of the plurality of interfaces; and
a processor coupled to the memory and configured to:
obtain pieces of information on a plurality of first packets that are transmitted and received to and from a virtual machine coupled to the management device through a first interface from among the plurality of interfaces and pieces of information on a plurality of second packets that are transmitted and received to and from a virtual machine coupled to the management device through a second interface from among the plurality of interfaces when the correspondence relationship information is changed, and
determine that a virtual router is deployed on the virtual machine when either the transmission source address or the destination address is identical between the set of the plurality of first packets and the set of the plurality of second packets, the virtual router transferring a packet between the first interface and the second interface and translating transmission source addresses or transmission destination addresses between the set of the plurality of first packets and the set of the plurality of second packets.

10. The management device according to claim 9, wherein the processor is configured to:
determine whether the number of first packets and the number of second packets are identical to each other when it is determines that the virtual router is deployed on the virtual machine, and
identify addresses before and after translation by the virtual router when it is determined that the number of first packets and the number of second packets are identical to each other.

11. The management device according to claim 9, wherein the processor is configured to:
determine whether an added virtual machine is coupled to two or more interfaces when the correspondence relationship information is changed due to addition of the virtual machine to the correspondence relationship information, and
perform setting that pieces of information on the plurality of first packets and pieces of information on the plurality of second packets are obtained when the added virtual machine is coupled to the two or more interfaces.

12. The management device according to claim 9, wherein the processor is configured to:
determine whether a deleted virtual machine is coupled to two or more interfaces when the correspondence relationship information is changed due to deletion of the virtual machine from the correspondence relationship information, and
perform setting so that pieces of information on the plurality of first packets and pieces of information on the plurality of second packets are not obtained when the deleted virtual machine is coupled to the two or more interfaces.
